(19) United States
(12) Patent Application Publication
(10) Pub. No.: US 2024/0044461 A1
(43) Pub. Date: Feb. 8, 2024

(54) Bi-directional tubular led light engine

(71) Applicant: Earth Lighting LLC, Sunnyvale, CA (US)

(72) Inventors: Donald A. Peifer, Mountain View, CA (US); James Albert Gavney, JR., Sunnyvale, CA (US); Todd Farmer, Dever, CO (US)

(73) Assignee: Earth Lighting LLC, Sunnyvale, CA (US)

(21) Appl. No.: 18/445,370

(22) Filed: Aug. 3, 2023

Related U.S. Application Data
(60) Provisional application No. 63/474,316, filed on Aug. 4, 2022.
(60) Provisional application No. 63/475,063, filed on Oct. 7, 2022.
(60) Provisional application No. 63/475,272, filed on Oct. 26, 2022.

(51) Int. Cl. F21S 4/28; F21K 9/272

(52) U.S. Cl. CPC F21S 4/28; F21K 9/272

(57) ABSTRACT

A T-LED light engine that provides up-light and down light. The T-LED has a top lens that emits a “bat-wing” light pattern and a bottom lens that emits a Lambertion light pattern. The T-LED light engine has an internal or on-board driver unit and/or on-board control unit. End caps of the T-LED light engine can be removed to service or replace internal components. The end caps have two-pin contact configurations that mate with tombstone style sockets or connectors and/or have bridge connector for connecting multiple T-LED light engines in series.

### RELATED APPLICATION

This application claims priority under 35 U.S.C. § 119(e) from the U.S. provisional patent application Ser. No. 63/474,316, filed on Aug. 4, 2022, and titled “LINEAR LIGHT FIXTURE WITH TUBULAR LIGHT ENGINE”, the U.S. provisional patent application Ser. No. 63/475,063, filed on Oct. 7, 2022, and titled “MODULAR BI-DIRECTIONAL TUBULAR LIGHT ENGINE” and the U.S. provisional patent application Ser. No. 63/475,272, filed on Oct. 26, 2022, and titled “BI-DIRECTIONAL LIGHT FIXTURE”. The U.S. provisional patent applications Ser. No. 63/474,316, Ser. No. 63/475,063 and Ser. No. 63/475,272 are all hereby incorporated by reference.

### FIELD OF THE INVENTION

This invention relates to lighting systems. More specifically, this invention relates linear LED light engines.

### BACKGROUND OF THE INVENTION

LED tube lamps, also referred to T-LEDs, are typically designed to physically fit in fixtures intended for fluorescent tubes. Some T-LED tubular lamps are intended to be a drop-in replacement into existing fixtures originally made fluorescent tube lamps where the appropriate ballast is used. Others fixture may require rewiring to remove the ballast and operated to power the LED tube lamp through an external LED driver.

An LED tube lamp generally uses many individual Surface-Mounted LEDs which are mono-directional and require proper orientation during installation as opposed to Fluorescent tube lamps which emit light in all directions around the tube. Specifically, most LED tube lamps do not emit light in an even 360 degree pattern as fluorescent tube lamps do, and some LED tube lamps have a beam pattern as low as 105 degrees, causing fixtures using these LED tube lamps to disperse light differently and/or to alter the amount of light available in the space.

### SUMMARY OF THE INVENTION

A T-LED of the present invention provides bi-directional light (up and down light). The T-LED of the present invention is also referred to herein as a modular bidirectional linear LED light engine. The bi-direction light is provided by a light strip (light bar) with a linear array of LEDs on a top surface of the light strip and a linear array of LEDs on a bottom surface of the light strip. The T-LED preferably has a top lens that emits a “bat-wing” light pattern and a bottom lens that preferably emits a Lambertion light pattern.

The T-LED also preferably includes and internal or on-board driver unit and can also include an internal or on-board control unit. The control unit can be configured for remotely controlling the T-LED, such as dimming the T-LED and/or independently controlling the top and bottom LED arrays. The T-LED is preferably serviceable or capable of being refurbished, where in end-caps can be removed and the LED strip or bar, driver circuit and/or control unit can be serviced or replaced.

The end-caps of the T-LED preferably have a two-pin contact configuration that mate with tombstone style sockets or connectors, similar to those used for fluorescent tube lamp fixtures (2-pin tombstone lighting format) and/or have a bridge connector configurations for connecting multiple T-LEDs in series or in a daisy-chain configuration through the bridge connector.

A LED light fixture of the present invention is preferably a pendent-type fixture that includes a housing with side panels that form an enclosure with an open top and open bottom and that has hanging hardware for suspending the LED light fixture from a ceiling or from a wall surface.

### BRIEF DESCRIPTION OF THE DRAWINGS

FIGS. 1A-B show a cross-sectional view and side-sectional view of an LED light fixture, respectively, with a modular bidirectional linear LED light engine, in accordance with the embodiments of the invention.

FIGS. 2A-B show a cross-sectional view a modular bidirectional linear LED light engine with a two-pin connector configuration and a tombstone-like connector or socket, respectively, for receiving the two-pin connector configuration, in accordance with the embodiments of the invention.

FIGS. 3A-B show a cross-sectional view a modular bidirectional linear LED light engine with an end cap for receiving a bridge connector and for connecting multiple modular bidirectional linear LED light engines in series or a daisy-chain configuration, in accordance with the embodiments of the invention.

FIGS. 4A-D show cross-sectional views of modular bidirectional linear LED light engine configurations, in accordance with the embodiments of the invention.

FIGS. 5A-D show LED light fixture configurations with modular bidirectional linear LED light engines, in accordance with the embodiments of the invention.

FIGS. 6A-D show removable end caps for modular bidirectional linear LED light engines with two-pin connector configurations for receiving internal or on-board drivers and/or control units, in accordance with the embodiments of the invention.

FIGS. 7A-E show views of components of a modular bidirectional linear LED light engines with a snap LED strip board connector for coupling to the removable end caps shown in FIGS. 6A-D, in accordance with the embodiments of the invention.

FIGS. 8A-B show views of modular bidirectional linear LED light engines with a up-light top optical element for generating a “batwing light” distribution from the modular bidirectional linear LED light engine, in accordance with the embodiments of the invention.

FIG. 9 shows a view of a pendent light fixture with a modular bidirectional linear LED light engine, in accordance with the embodiments of the invention.

FIGS. 10A-B show views of modular bidirectional linear LED light engines with bridge connector configurations for connecting multiple modular bidirectional linear LED light engines in series or a daisy-chain configuration, in accordance with the embodiments of the invention.

### DETAILED DESCRIPTION OF THE INVENTION

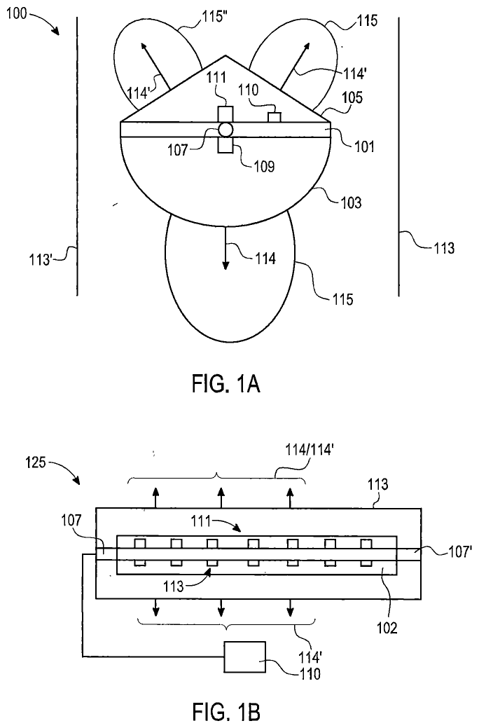

Referring to FIGS. 1A-B, the T-LED light engine 100 can include an internal or on-board AC to DC conversion driver circuit 110 (driver circuit) and/or control unit 110 or external AC to DC conversion driver circuit 110′ (driver circuit) and or control unit 110′, such that the T-LED light engine 100 can be connected directly to 120V line voltage. Where the T-LED includes a control unit 110/110′, the control unit control unit 110/110′ can be configured for remotely controlling the T-LED 100, such as dimming the T-LED 100 and/or for independently controlling top and bottom linear LED arrays 111/109. Alternatively, the T-LED light engine 100 can include a DC back boost converter, such that the T-LED light engine 100 can replace conventional fluorescent tube lights that are powered by a ballast or the T-LED light engine 100 can be configure to be powered by and external AC to DC conversion LED driver circuit.

The T-LED light engine 100 has a light strip or light board 101, also referred to herein as a bidirectional light strip or light board, supports the top linear array of LEDs 111 and the bottom linear array of LEDs 109 for emitting bi-directional up-light, represented by the arrows 114′ and 114″, and the down light, represented buy the arrow 114. The up-light distribution emitted by the T-LED 100 is preferably represented by a “bat-wing” light distribution, represented by 115′ and 115″ and the down-light distribution emitted by the T-LED 100 is preferably Lambertian represented by 115. The T-LED light engine 100 also include one or more end connectors 107/107′ for connecting the T-LED to a power source.

The T-LED light engine 100 also includes an optical housing 102 that encloses the light strip or light board 101 and internal or on-board AC to DC conversion driver circuit/control circuit 110.

The optical housing 102 includes a top linear optical element 105 and a lower linear optical element 103. Where the T-LED 100 is utilizes in a pendent-type light fixture 125, the LED light fixture 125 includes an elongated housing with side panels 113/113, wherein the top and the bottom of the elongated housing is open, also referred to herein as a shroud housing.

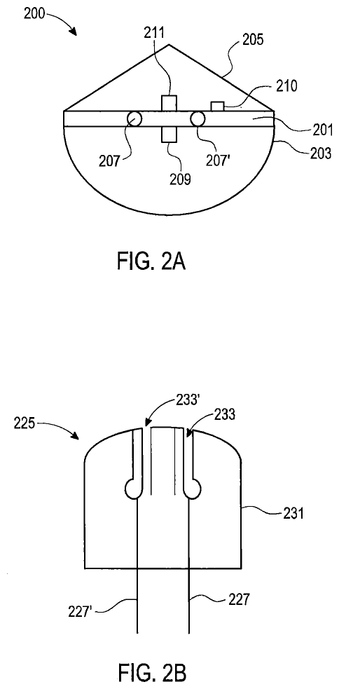

Referring to FIGS. 2A-B, a T-LED light engine 200 of the present invention includes light strip or light bar 201 that has a top linear array of LEDs 211 and a bottom linear array of LEDs 209 for emitting bi-directional light, such as described above. The T-LED 200 light engine also includes an internal or on-board driver circuit and/or controller circuit 210. The light strip or light board 201 is enclosed in a linear optical housing that includes a top optical element 205 and bottom optical element 203. The T-LED 200 light engine has pin connectors 207 and 207′ for electrically coupling the T-LED light engine 200 to a power source and for energizing and powering the internal or on-board driver circuit and/or controller circuit 210 and LED light strip or light bar 201.

Preferably the T-LED 200 includes a two-pin contact configuration 207/207′ that mates with tombstone style socket or connector 225. The tombstone style socket or connector 225 includes a support structure 231 with connector slots 233 and 233′ for receiving the pin connectors 207 and 207′. The connector slots 233 and 233′ include conducive contacts that connect to power connections 227 and 227′ that can be line-voltage as described above.

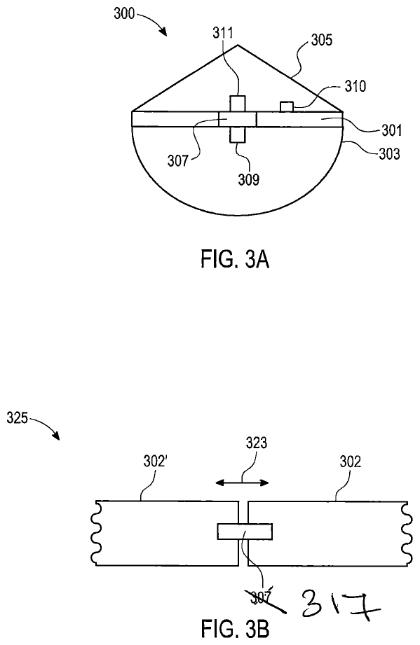

Referring to FIGS. 3A-B, in accordance with further embodiments of the invention, a T-LED light engine 300 includes an light strip or light bar 301 that has a top linear array of LEDs 311 and a bottom linear array of LEDs 309 for emitting bi-directional light, such as described above. The T-LED light engine 300 also includes an internal or on-board driver circuit and/or controller circuit 310. The light strip or light bar 301 is enclosed in a linear optical housing that includes a top optical element 305 and bottom optical element 303. The T-LED light engine 300 has bridge connector socket 307 on one end of the T-LED 300 light engine and pin connectors on the opposite end of the T-LED light engine 300, such as the pin connectors 207 and 207′ described with reference to FIG. 2A.

The bridge connector socket 307 allows multiple T-LED light engines 302 and 302′ (such a the T-LED light engine 300) to be connected to a bridge connector 317. In operation the bridge connector 317 provides all the electrical contacts for connecting the multiple T-LED light engines 302 and 302′ in a series or in a daisy-chain configuration 325 through bridge connector 317 be pushing the multiple T-LED light engines 302 and 302′ together, as indicated by the arrow 323, with the bridge connector sockets, such as 307, on each of the multiple T-LED light engines 302 and 302′ aligned with the bridge connector 317. At least one end of one of the multiple T-LED light engines 302 and 302′ includes connectors, such as pin connectors (207/207; FIG. 2A) for connecting the daisy-chain configuration 325 of T-LED light engines 320/302′ to a power supply and powering the daisy-chain configuration 325 of T-LED light engines 320/302′.

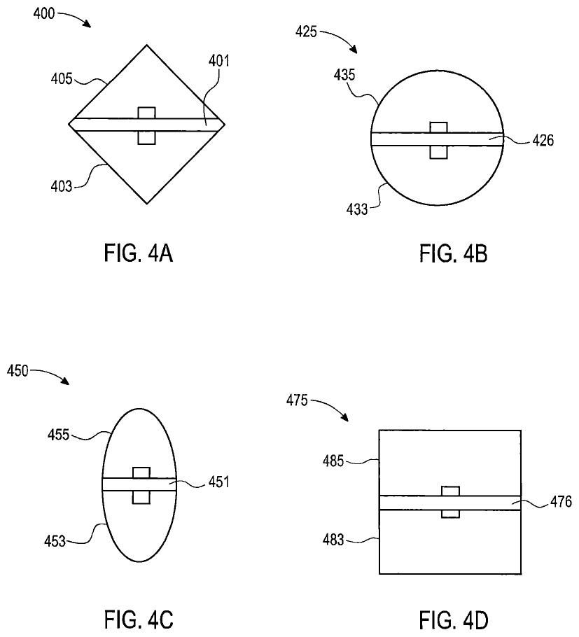

FIGS. 4A-D show bidirectional linear LED light engines (T-LED) configurations 400, 425, 450 and 475, with different optical housing (102; FIG. 1B) shapes or geometries. The T-LED light engine configuration 400 includes a bidirectional light strip or light bar 401 with an angled top optic element 405 and an angled bottom optical element 403; the T-LED light engine configuration 425 includes a bidirectional light strip or light bar 426 with a rounded top optic element 435 and a rounded bottom optical elements 433; the T-LED light engine configuration 450 includes a bidirectional light strip or light bar 451 with a oval top optic element 455 and a oval bottom optical elements 453; and the T-LED light engine configuration 475 includes a bidirectional light strip or light bar 476 with a rectangular top optic element 485 and a rectangular bottom optical elements 483.

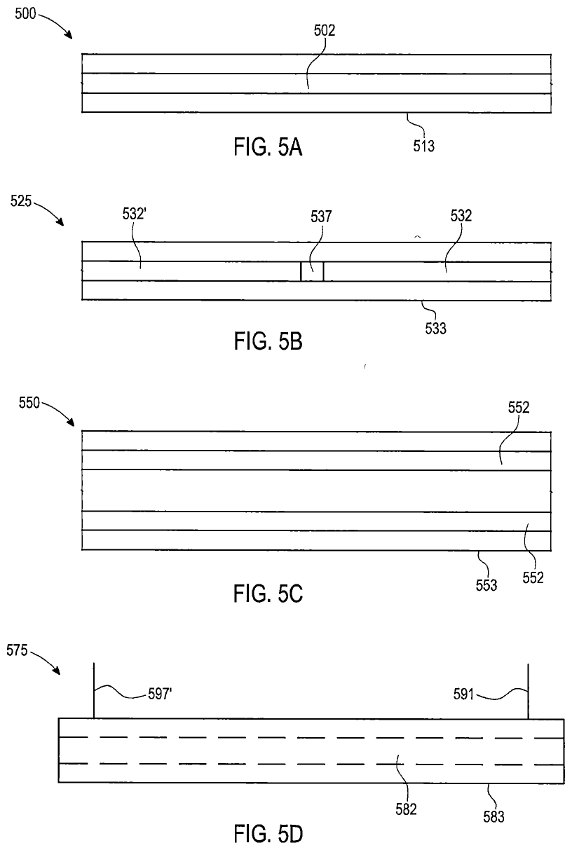

FIGS. 5A-D show LED light fixture configurations 500, 525, 550 and 575 with modular bidirectional linear LED light engines. The LED light fixture configurations 500 utilizes a single modular bidirectional linear LED light engine 502 with a surrounding shroud housing 513; the LED light fixture configurations 525 utilizes a multiple bidirectional linear LED light engines 532/532′ electrically connected together a bridge connector 537, such as described with reference to FIGS. 3A-B, with a surrounding shroud housing 533; and the LED light fixture configurations 550 utilizes a multiple bidirectional linear LED light engines 552/552′ positioned in a side-by side configuration and with a surrounding shroud housing 553. The LED light fixture configuration 575 is a suspended pendent styles LED light fixture configuration 575 with a modular bidirectional linear LED light engine 582 surrounded by a shroud housing 583. The LED light fixture configuration 575 includes hanging hardware, such tubes or cables 591/591 for suspending the LED light fixture configuration 575 from a ceiling.

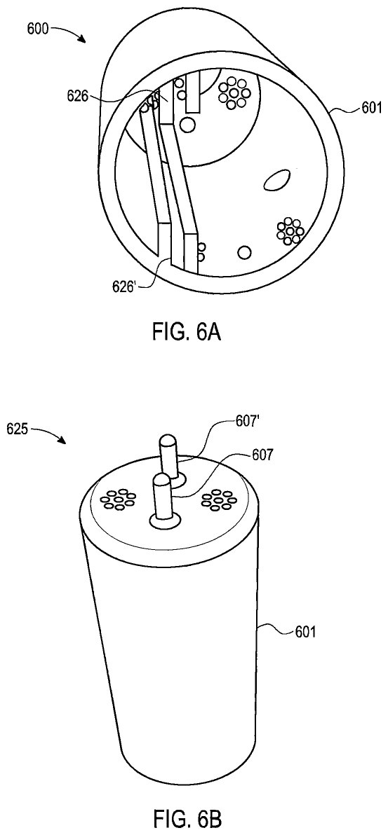

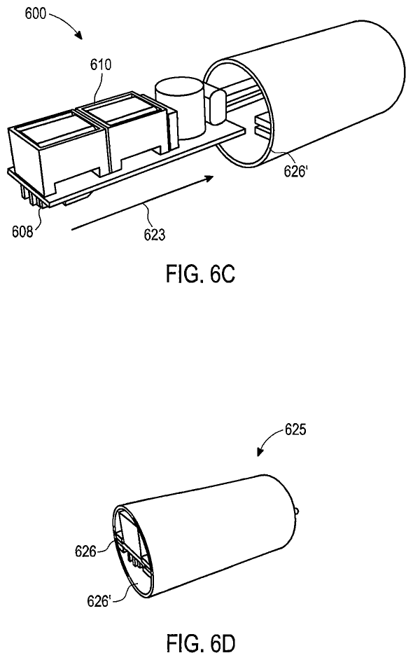

FIGS. 6A-D show views 600 and 625 of removable end cap 601 used for the modular bidirectional linear LED light engines of the present invention. The removable end cap 601 has a two-pin connector configurations 607/607′ and is configured for receiving an internal or on-board driver and/or control unit 610. The removable end cap includes slotted features 626 and 626′ for supporting the internal or on-board driver and/or control unit 610 when assembled, as indicated by the arrow 623. With the internal or on-board driver and/or control unit 610 installed in the removable end cap 601, the internal or on-board driver and/or control unit 610 is placed in electrical communication the two-pin connector configurations 607/607′. Preferably, the on-board driver and/or control unit 610 includes an electrical socket 608 for plugging in and electrically connecting the linear light strip or light bar 701 to the on-board driver and/or control unit 610.

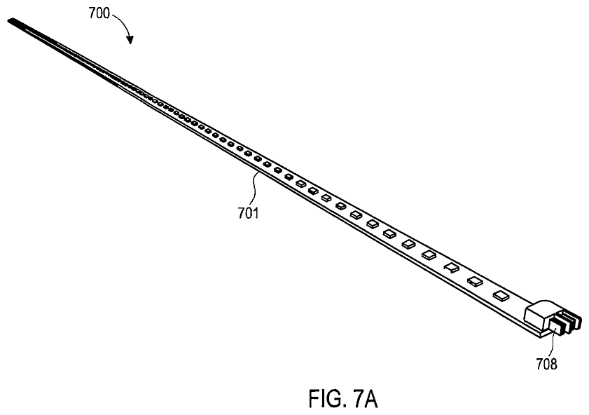

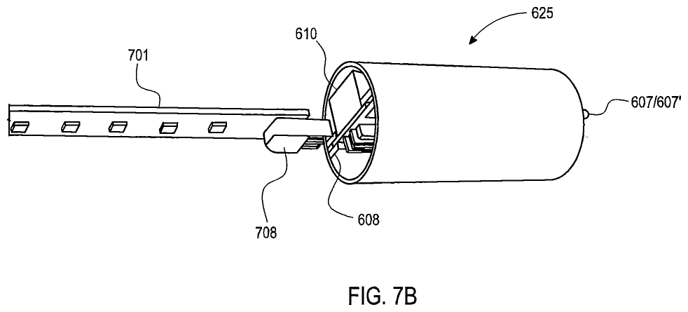

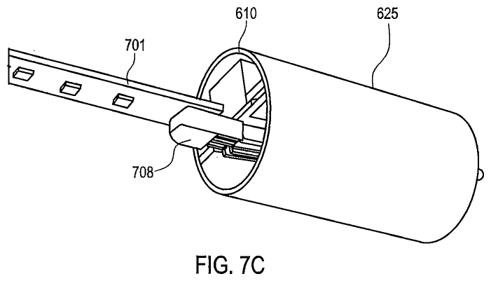

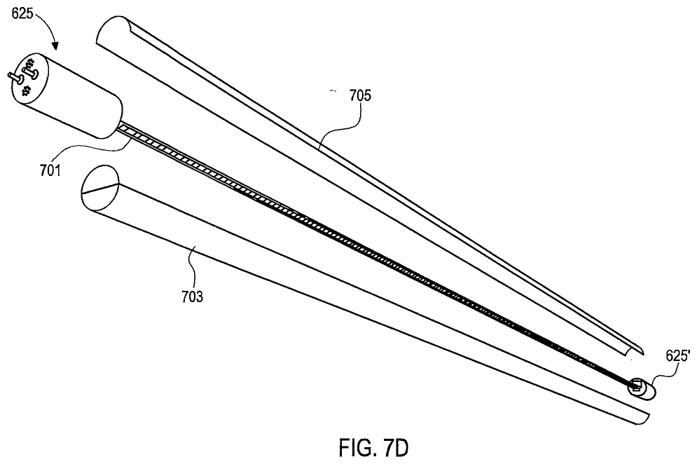

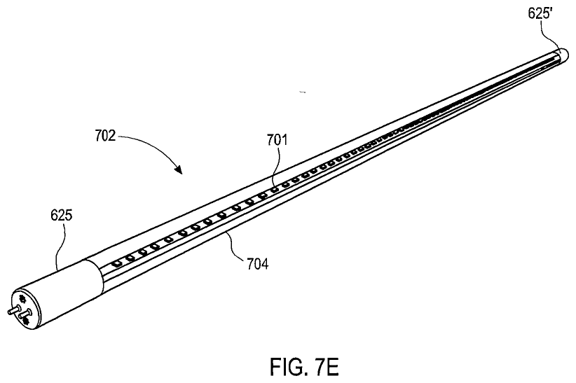

FIG. 7A shows a view 700 of the linear light strip or light bar 701 with an electrical plug 708 for placing in the electrical socket 608 (FIG. 6C). FIG. 7B shows aligning electrical plug 708 on the end of the linear light strip or light bar 701 with the electrical socket 608 on the internal or on-board driver and/or control unit 610 with the on-board driver and/or control unit 610 posited within the assembled end cap 625 having the two-pin connector configurations 607/607′. FIG. 7C shows the assemble end cap 625 with the electrical plug 708 on an end of the linear light strip or light bar 701 connected to the electrical socket 608. FIG. 7D shows an exploded view of a T-LED light engine 702 (FIG. 7E) with removable end caps 625/625′ connected to both ends of the linear light strip or light bar 701. The end-cap 625 includes a internal or on-board driver and/or control unit 610 and a two-pin connector configurations 607/607′, as described above. The end cap 625′ can also have two-pin connector configurations 607/607′, but does not necessary proved electrical contacts or connections to the linear light strip or light bar 701. The T-LED light engine 702 also includes a top optical element 705 and a bottom optical element 703. FIG. 7E shows the fully assembled T-LED light engine 702, wherein the end caps 625/625′ hold the top optical element 705 and an bottom optical element 703 together to form an optical enclosure 704 that surrounds the linear light strip or light bar 701.

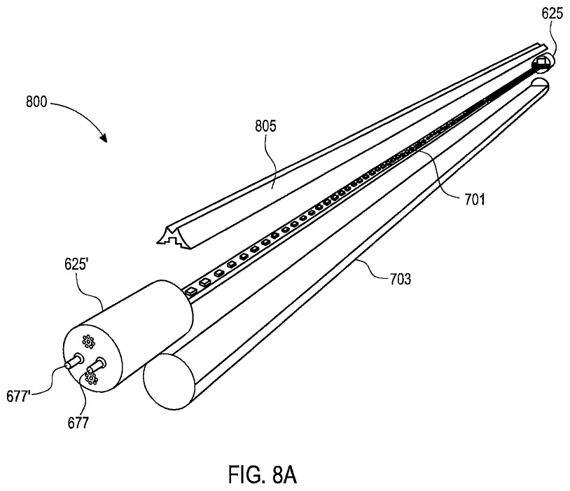

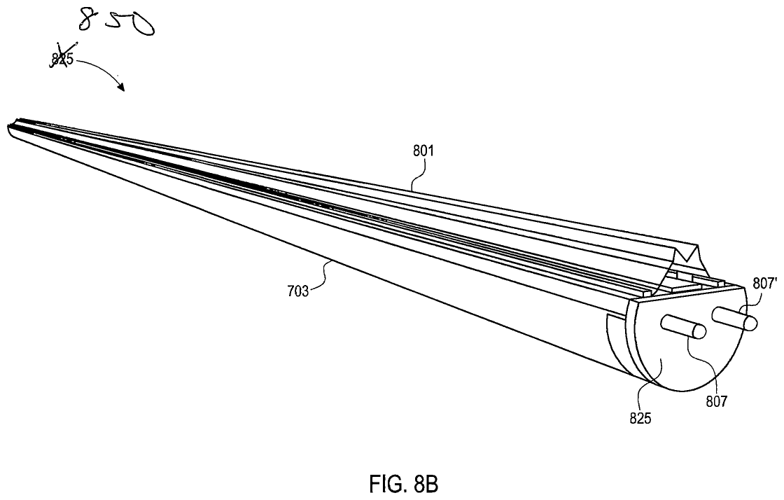

FIG. 8A shows an exploded view of a T-LED light engine 800 with removable end caps 625/625′ connected to both ends of the linear light strip or light bar 701. The end-cap 625 includes an internal or on-board driver and/or control unit 610 and has a two-pin connector configurations, as described above. The end cap 625′ can also have two-pin connector configurations 677/677′, but does not necessary proved electrical contacts or connections to the linear light strip or light bar 701. The T-LED light engine 800 also includes a top optical element 805 and a bottom optical element 703. The top optical element 805 when assembled preferably provide by a “bat-wing” up-light distribution and the bottom optical element 703 provides a Lambertian down-light distribution, when the linear light strip or light bar 701 is energized.

FIG. 8B shows the fully assembled T-LED light engine 850, similar to the T-LED light engine 800. In the T-LED light engine 850, the end caps 825 have a two-pin connector configurations that are directly connected to electrical contacts on the linear light strip or light bar 701, but the end caps 825 do not house an internal or on-board driver and/or control unit 610. The T-LED 850 light engine requires an external AC to DC conversion driver circuit to operate. The T-LED 850 light engine also includes top optical element 801 and a bottom optical element 703 together to form an optical enclosure that surrounds the linear light strip or light bar 701, as described above. The benefit of the T-LED 850 configuration is the there are no light “dead zones” near ends of the T-LED light engine 850 with the linear light strip or light bar 701 is energized.

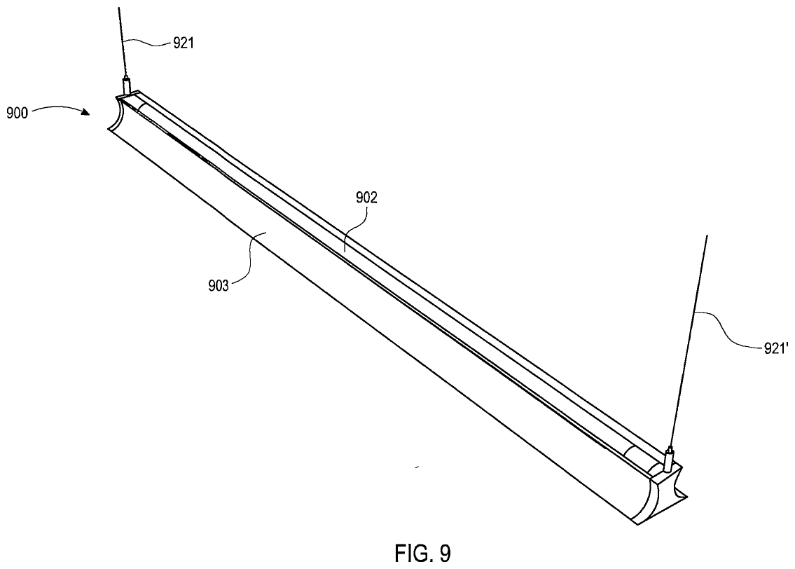

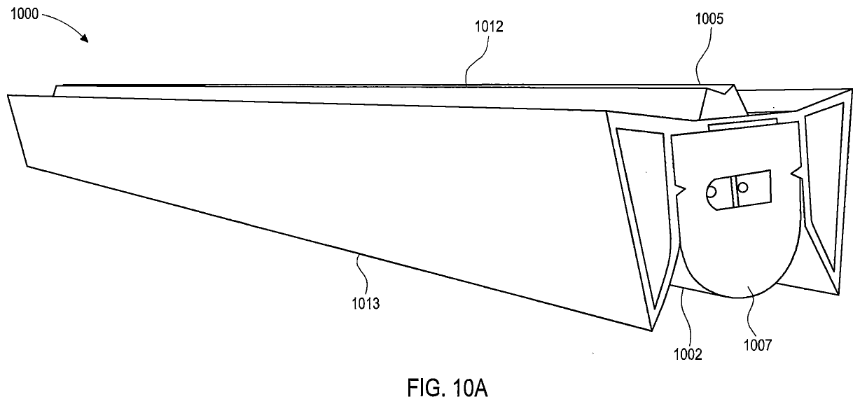

FIG. 9 shows a pendent-type light fixture 900 with an T-LED light engine 902, such as 702, 800, or 850. The pendent-type light fixture 900 includes hardware, such as cables 921 and 921′ for suspending the pendent-type light fixture 900 from a ceiling. Where the T-LED 902 requires an external AC to DC conversion driver circuit to operate, one or both of the cables 921 and 921′ can be power cables. The pendent-type light fixture 900 includes an elongated housing 903 with side panels (housing shroud), wherein the top and the bottom of the elongated housing 903 is open.

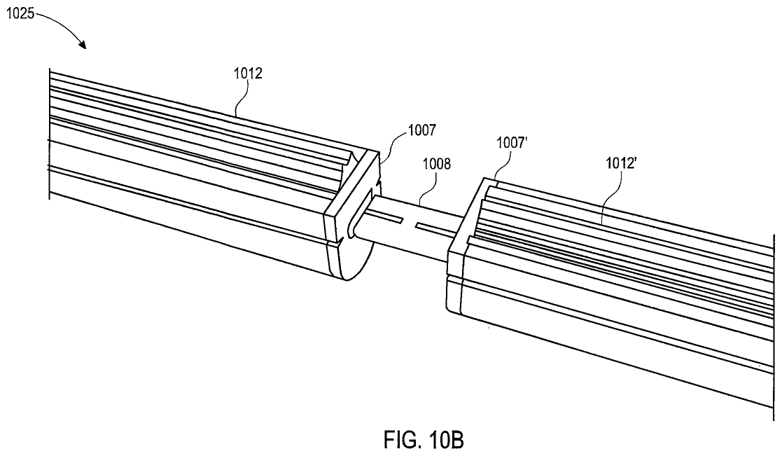

FIG. 10A shows a view of T-LED unit 1000 that includes a T-LED light engine 1012, such as 702, 800 or 850. The T-LED unit 1000 also includes integrates housing 1013 that clips on to a body portion of the T-LED light engine 1012. The T-LED light engine 1012 includes linear light strip or light bar 701 with or without an internal or on-board driver and/or control unit 610. The T-LED light engine 1012 also includes top optical element 1005 and a bottom optical element 1002. The top optical element 1005 preferably provides a “bat-wing” light distribution and the bottom optical element 1002 preferably provide a Lamberation light distribution when the linear light strip or light bar 701 is energized. The T-LED light engine 1000 has at least one end that includes bridge connector socket 1007.

Referring to FIG. 10B, the bridge connector socket 1007 allows multiple T-LED light engines 1012 and 1012′, to be connected together through a bridge connector 1008. In operation the bridge connector 1008 provides all the electrical contacts for connecting the multiple T-LED light engines 1012 and 1012′ in a series or in a daisy-chain configuration 1025 through the bridge connector 1008 by pushing the multiple T-LED light engines 1012 and 1012′. Opposite end of the multiple T-LEDs 1012 and 1012′ have pin connectors for mating with a tombstone-type socket, such as describes above.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention. For example, while the T-LED light engines of the present invention are described for use in pendent-type wall or ceiling mounted light fixtures, the T-LED light engines can also have applications in troffer-type ceiling mounted fixtures that have up-light reflectors.

What is claimed is:

1. A tubular LED light engine comprising:
an elongated optical housing;
an LED strip contained within the elongated optical housing with LEDs on both of opposed sides of the LED strip for providing bi-directional up-light and down-light; and
an on-board LED power driver and/or control driver for powering and/or controlling the LED strip through electrical contacts, wherein tubular LED light engine provides a bat-wing up-light distribution.

2. The tubular LED light engine, wherein the electrical contacts are pins and the LED light engine fits into a 2-pin tombstone lighting format.
